(19) United States
(12) Patent Application Publication
(10) Pub. No.: US 2015/0127533 A1
(43) Pub. Date: May 7, 2015

(54) AUTHORIZATION OF CHECK DEPOSITS

(71) Applicants: Kai Knebel, Paderborn (DE); Oliver Luecking, Paderborn (DE)

(72) Inventors: Kai Knebel, Paderborn (DE); Oliver Luecking, Paderborn (DE)

(73) Assignee: WINCOR NIXDORF INTERNATIONAL GMBH, Paderborn (DE)

(21) Appl. No.: 14/239,485

(22) PCT Filed: Aug. 13, 2012
(86) PCT No.: PCT/EP2012/065792

§ 371 Date: May 29, 2014

(30) Foreign Application Priority Data
Aug. 16, 2011 (DE) 10 2011 052 751.6

(51) Int. Cl. G06Q 20/04; G06Q 20/40; G06Q 20/10; G06K 9/78; G06K 9/00

(52) U.S. Cl. CPC G06Q 20/042; G06K 9/78; G06K 9/00469; G06Q 20/1085; G06Q 20/40
USPC 705/43

(57) ABSTRACT

A method for authorizing check deposits includes digitally recording a check; using digital image recognition methods to determine digital check data which describe the issuer, the recipient and the sum of the check; and authorizing the further processing of the check if one or more of the following steps are successful: a) checking, in a database protected from external access, whether the issuer of the check has cleared the recipient by comparing the digital check data with data from the database; and b) loading digital communication addresses of the issuer from a database protected from external access, transmitting the digital check data to the communication address with the request to digitally clear the check, and receiving digital clearance of the check from the issuer.

### BACKGROUND

1. Field of the Invention

The invention relates to a method and an apparatus for depositing checks, in particular using a self-service machine/ATM or a combined cash/check machine which allows both checks and money to be accepted, in which case money can also be additionally dispensed. In detail, the invention relates to an information interchange method which is used to inform issuers of a check when depositing a check, thus making it difficult to forge the check.

2. Description of the Related Art

Nowadays, customer checks can be deposited in check deposit terminals (called self-service machines or else ATM). The checks are processed without validation and the customer receives a receipt indicating that he has deposited the check(s). Until the amount is booked or there is a transaction, the checks from the terminals must be sent to so-called clearing centers. This is carried out using the normal mailing route. This results in the check amount being validated and definitively booked only after a few days or weeks.

The document WO 99/11021 and the entries under Check 21 Act in Wikipedia describe the handling of checks as scanned data. However, exact implementation with respect to a self-service machine has not been disclosed.

It is also problematic that forged checks can be deposited and the victim learns of this only after he receives a corresponding account statement.

Even if the checks are not scanned by a self-service machine itself but rather in a corresponding central apparatus, the weakness in check processing is the transition from the physical check to the virtual check. That is to say, the transition from the physical check to data in the transaction processing unit can be used for fraudulent purposes. Such transaction processing units then transfer the money. Different fraudulent scenarios ensue here. It is easy and effective to create a simple paper copy or to manipulate data on the check, for example. Hardware solutions are extremely complicated and partly also presuppose adaptations to the paper check itself.

### SUMMARY OF THE INVENTION

One preferred embodiment provides an information method which allows the recipient to be digitally stipulated in advance when depositing a check, with the result that the data relating to the check are then digitally recorded by means of a scan in order to then initiate a challenge response method, after the check has been deposited, in which check data information is transmitted to a terminal belonging to the check issuer, on which the user must provide a confirmation or must clear the further processing. In an alternative embodiment which can also be carried out in combination with the abovementioned method, the issuer of the check already stipulates in advance on a digital system who can receive the check, with the result that the data can accordingly be compared when digitally reading in the check.

In detail, the method for authorizing check deposits comprises the following steps.

In a first step, a check is digitally recorded. In this case, a scanning apparatus which generally operates optically generates a digital data stream in the form of an image which is then evaluated using digital image recognition methods in order to record digital check data which describe the issuer, the recipient and the sum of the check. Known OCR methods can be used in this case. It is also possible to use templates which take into account the format structure of the checks and therefore simplify recognition. In one possible embodiment, the issuer information may have already been digitally coded in the check. Barcodes or other coding systems which can be optically recorded in a simple manner can therefore be used to discern the details using an automated method. Other coding systems, for example radio coding systems, may also be contained in the check and make it possible to read out the issuer data. RFID is mentioned here, for example.

Authorization is carried out in a second step. The check can be processed further only if one or more of the following steps are successful. It is therefore possible to carry out the steps in combination or individually, depending on the users' requirements and desire.

As one possibility, a check is carried out, in a database protected from external access, in order to determine whether the issuer of the check has cleared the recipient by comparing the digital check data with data from the database. This is a database which is created and operated for each user/check issuer. This database is protected by passwords or digitally signed cards and allows only entries by corresponding persons who have the access data. The data relating to the recipient, the latter's account data (account number, bank sort code), the amount and/or the check number are entered in the database which is generally operated on a server by the bank or a service provider working for the bank, with the result that the check which is subsequently issued can be uniquely identified. The data stored in this manner express the fact that only checks which satisfy the corresponding criteria are issued.

A further approach in terms of protection which can likewise be used comprises loading digital communication addresses of the issuer from a database protected from external access, transmitting the digital check data to the communication address with the request to digitally clear the check, and receiving digital clearance of the check from the issuer. In this case, messages such as SMS, MMS, emails or other short messages are sent to the issuer who can then clear the check by responding to said messages. The response can be effected by means of a response message containing correspondingly unique data which make recognition possible or by means of a link which should be clicked on so that the issuer enters the World Wide Web (WWW) in order to look at the data there using a browser and to clear the data. Other response approaches which use signatures or encryption methods are likewise conceivable. In one possible embodiment, an SMS containing a link to a website/web portal is transmitted, in which case the user must clear the check by clicking on said link. Signed response emails or the prior encryption of information, which can be decrypted only by the recipient, are also conceivable. When visiting the web portal, access data may possibly need to be input again in order to then actually access the recorded check data.

Furthermore, a communication address may likewise be stored for the check recipient in a database which is possibly identical to the database for the issuer of the check and which stores digital communication addresses for the check recipient, with the result that the recipient is additionally informed of the authorization process by sending digital messages. A gradual check of the authorization process can therefore be observed both by the issuer and by the recipient. This makes it possible for digital information to be automatically sent both to the issuer and to the recipient at different points in the processing process in order to make the procedure more customer-friendly.

In the infrastructure, the checks are preferably accepted by a self-service machine which digitally records the check and preferably also determines the check data using digital image recognition methods in order to then send this information, via a network, to an authorization system which controls the authorization of the further processing. In an alternative system, it is likewise possible for the self-service machine to only carry out the scanning process and for the other recognition procedures to run in the background. It is also possible for the self-service machine, to which the check is supplied, to request the user/recipient to enter the communication address so that he is able to follow the processing process. The processing is generally effected in the background using secure transaction computer systems which have access to the database which stores the personal communication addresses of the issuer and also the details of the amount of the check and the name and personal data of the recipient. Furthermore, photographs of the check can be taken and are stored in the database. These photographs can be uploaded, for example, using a special application/app; this process can be automated. It is therefore possible to use a mobile device such as an iPhone or PDA (android) etc. to take a photograph of the check in order to then securely upload this photograph to the transaction server in a substantially automatic manner. Accordingly, passwords should be taken into account and may be pre-stored in the application. This database may be a central database which is operated on a server by a multiplicity of bank operators, or each bank has its own database, in which case access which should generally only be read access is effected by a check processing system, as described below. In principle, it is conceivable for the method to be implemented on a single system, for example self-service machine, but it can be assumed that the tasks are generally distributed to a plurality of computers which are connected via a network and therefore form a system.

The system for authorizing check deposits comprises the following components:

A digital recording unit for scanning a check. In the preferred embodiment, this recording unit is in the form of a self-service machine in which the user can deposit the check. This self-service machine can also enable additional functions, such as the payment of money. In one embodiment, it is therefore conceivable for the self-service machine to independently carry out the transaction and to wait for the clearance from the issuer, with the result that the recipient immediately receives cash for the check. In another embodiment, the recipient can immediately enter an account number and a name in order to determine the destination of the check.

Another component is a digital image recognition unit for determining the digital check data, which determine the issuer, the recipient and the sum of the check, using digital handwriting recognition methods. As already described above, this may be an optical machine scanner or another machine scanner which is able to automatically record the data. This unit may likewise be arranged in the self-service machine.

Another component is the authorization unit for clearing the further processing of the check, having a network interface and a digital processing unit which are set up and designed in such a manner that further processing of the check is cleared if one or more of the following conditions are met:
a) the processing unit checks, in a database protected from external access, whether the issuer of the check has cleared the recipient by comparing the digital check data with data from the database;
b) the processing unit loads digital communication addresses of the issuer from a database protected from external access, the digital check data are transmitted to the communication address with the request to digitally clear the check, and digital clearance of the check is received from the issuer.

The components used in this case are often server systems which are controlled using appropriate software. A processing unit is therefore generally one or more processors, a network unit and a network interface to a network.

The solution approach is therefore that the check issuer authorizes the recipient in advance. This can operate using online portals, for example. In this case, the issuer can predefine the destination account number or the name online, for example. When depositing a check, the authorization can now be processed in a fully automatic manner since the check can be allocated only to the correct recipient. Information can now also be sent both to the issuer and to the recipient at different points in the processing process in order to make the procedure more customer-friendly.

It is novel that the authenticity of the check is confirmed by the person who ultimately bears the costs of the check. Integrating the recipient data right at the beginning of the check processing process means that a confidence bonus for the check recipient is integrated in the process here in good time. It is also possible for the check issuer to transmit a photograph of the check to the check process online, with the result that, for example in addition to the recipient's name, the scanned images and the photographs can be compared with one another here. The great advantage is that fraud when depositing checks, whether by using copies of checks or by manipulating signatures or amounts, is made considerably more difficult since issuers and recipients can stipulate the value and also the actual recipient in advance. It directly follows from this that the automation can be considerably expedited and the acceptance of electronic check deposit is increased. Another alternative or a solution approach which can be used in combination would be for the check issuer to be integrated in the check validation process again after the check recipient has deposited the check in the ATM. This is effected, for example, by means of an SMS, an email or by visiting a web portal. The issuer can authorize the check in real time there. The contact data for the issuer should accordingly be stored. The check recipient can now be additionally informed that the check amount is available for full payment.

### BRIEF DESCRIPTION OF THE DRAWINGS

FIG. 1 shows individual method steps of the invention during check acceptance and payment, in which case authorization is carried out in advance.

FIG. 2 shows individual method steps of the invention during check acceptance and processing, in which case authorization is carried out afterward.

### DETAILED DESCRIPTION OF THE PREFERRED EMBODIMENTS

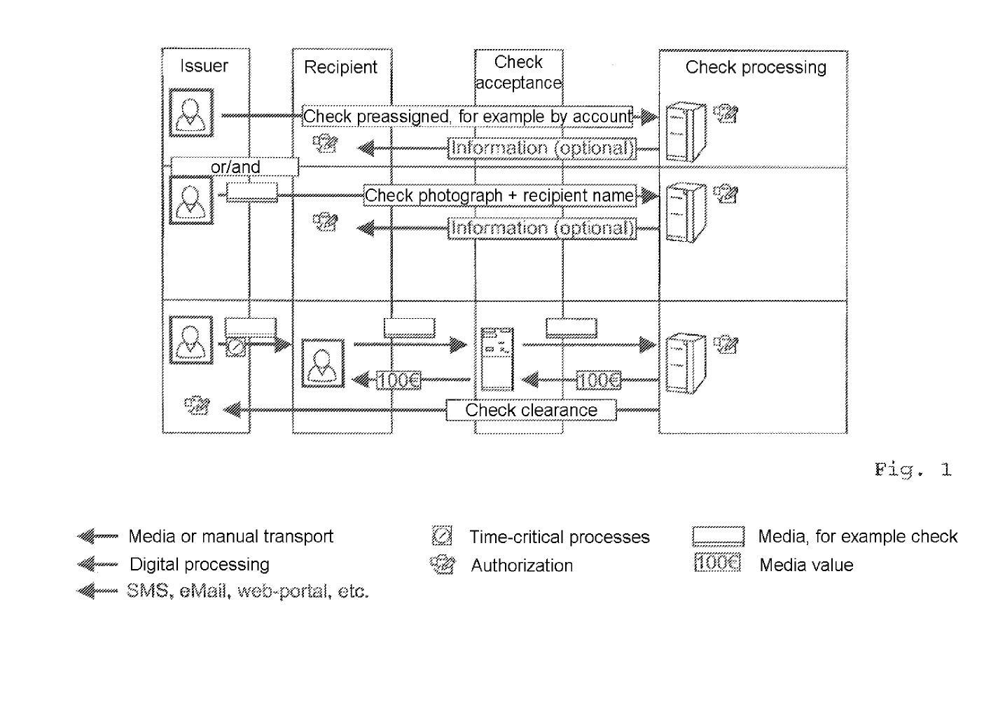

FIG. 1 shows the communication paths between the issuer, the recipient, check acceptance and processing. In this case, check acceptance generally represents a self-service machine which is connected, in the background, to a transaction system corresponding to processing. In the first upper part of FIG. 1, the issuer transfers user information and destination account information to the check processing system, in which case information indicating that a check can be expected has already been transmitted to the recipient at this time. However, this information is optional.

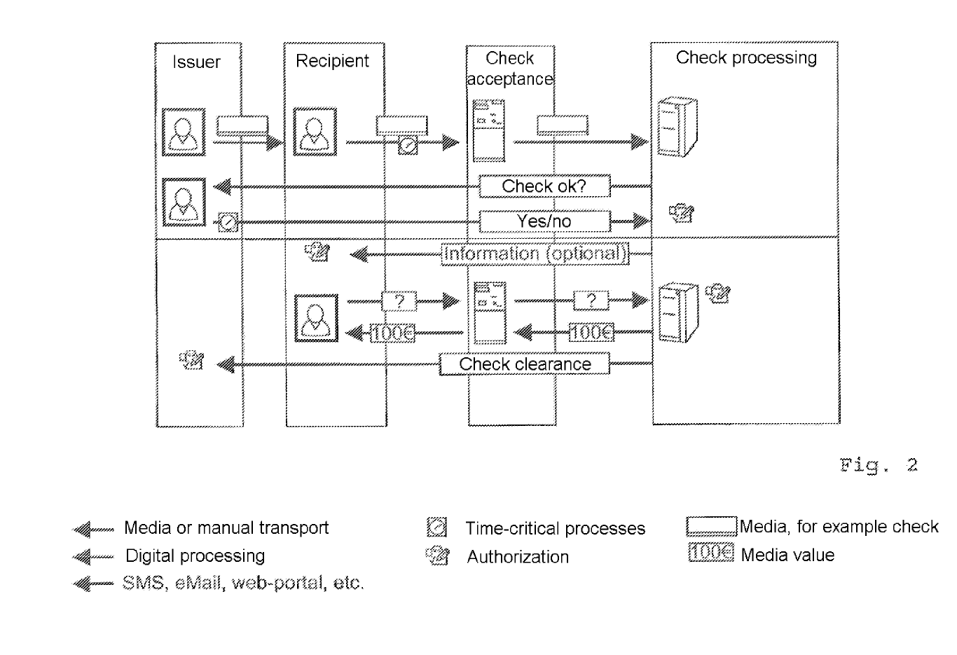

In an alternative approach, check photographs and the name of the recipient are entered and are transmitted to the check processing system, in which case the information is likewise optionally forwarded to the recipient. During the last actual handover of the check, the issuer passes the check to the recipient. The latter transfers the check to the self-service machine. The self-service machine forwards the digital data to the check processing which checks whether the amount can be paid using the photograph and the recipient name or the account number which has been pre-entered. The check processing clears the [symbol] 100, for example, which are on the check and the self-service machine gives the [symbol] 100 to the recipient in cash. Optionally, the issuer is naturally informed of this process and must clear the check using a message method, as described above or in the claims, or as illustrated in FIG. 2. In FIG. 2, the issuer of the check is informed by the recipient when depositing the check that a check which debits his account has been deposited. The issuer must now clear this check by answering yes or must reject the check by answering no. After the check has been cleared, the amount is paid to the recipient. The question marks represent a dialog which is conducted with the device in which details such as payment form (cash or to an account) are accordingly queried on request. A payment is then made, thus concluding the check processing.

1. A method for authorizing check deposits, comprising the steps of:
digitally recording a check;
using a digital image recognition method to determine digital check data which describe the issuer, the recipient and the sum of the check;
authorizing the further processing of the check if one or more of the following steps are successful:
a) checking, in a database protected from external access, whether the issuer of the check has cleared the recipient or the check by comparing the digitally recorded check data with data from the database;
b) loading digital communication addresses of the issuer from a database protected from external access, transmitting the digital check data to the communication address with the request to digitally clear the check, and receiving digital clearance of the check from the issuer.

2. The method of claim 1, wherein the digital check data are transmitted by SMS, MMS, email or with a message containing a request to visit a web portal, and wherein the message is confirmed and the check is authorized by response SMS, MMS, email or by visiting a web portal and the clearance there.

3. The method of claim 1, wherein digital communication addresses are stored for the check recipient in a protected database, with the result that the recipient is additionally informed of the authorization process by sending digital messages.

4. The method of claims 1, wherein at least one of check number, name of the recipient, destination account number, destination account sort code, and digital image data for the check are stored in the database protected from external access and in which the issuer of the check has cleared the recipient.

5. The method of claim 1, wherein digital information is automatically sent both to the issuer and to the recipient at different points in the processing process in order to make the procedure more customer-friendly.

6. The method of claim 1, wherein the check is accepted by a self-service machine which digitally records the check and preferably also determines the check data using digital image recognition methods in order to then send this information, via a network, to an authorization system which controls the authorization of the further processing.

7. A system for authorizing check deposits, comprising the following components:
a digital recording unit for scanning a check;
a digital image recognition unit for determining the digital check data, which describe the issuer, the recipient and the sum of the check, using digital image recognition methods;
an authorization unit for clearing the further processing of the check, having network interfaces and a digital processing unit which are set up and designed in such a manner that further processing of the check is cleared if one or more of the following steps are successful:
a) the processing unit checks, in a database protected from external access, whether the issuer of the check has cleared the recipient or the check by comparing the digital check data with data from the database;
b) the processing unit loads digital communication addresses of the issuer from a database protected from external access, the digital check data are transmitted to the communication address with the request to digitally clear the check, and digital clearance of the check is received from the issuer.

8. The system of claim 7 set up to transmit the digital check data by SMS, MMS, email or to transmit a request to visit a web portal and to receive a confirmation message for authorizing the check by SMS, MMS, email or a message via the web portal.

9. the system of claim 7, wherein digital communication addresses are stored for the check recipient in a protected database, and wherein the processing unit informs the check recipient of the authorization process via the network interface by sending digital messages.

10. the system of claim 7, wherein one or more of the following data items are stored in the database which is protected from external access and in which the issuer of the check has cleared the recipient: check number, name of the recipient, destination account number, destination account sort code, digital image data for the check.

11. The system of claim 7, wherein the processing unit and the network unit automatically send digital information both to the issuer and to the recipient at different points in the processing process in order to make the procedure more customer-friendly.

12. system of claim 7, wherein the check is accepted by a self-service machine which digitally records the check and preferably also determines the check data using digital image recognition methods in order to then send this information, via a network, to an authorization system which controls the authorization of the further processing.
